(19) United States
(12) Patent Application Publication
(10) Pub. No.: US 2017/0052393 A1
(43) Pub. Date: Feb. 23, 2017

(54) EYEGLASS LENS SIMULATION SYSTEM USING VIRTUAL REALITY HEADSET AND METHOD THEREOF

(71) Applicant: ViewITech Co., Ltd., Anyang City (KR)

(72) Inventor: Hyuk Je Kweon, Gwacheon-si (KR)

(21) Appl. No.: 14/866,109

(22) Filed: Sep. 25, 2015

(30) Foreign Application Priority Data
Aug. 18, 2015 (KR) 10-2015-0116072

(51) Int. Cl. G02C 13/00; G02B 27/00; G02B 27/01; G06T 19/00; G06F 3/01

(52) U.S. Cl. CPC G02C 13/003; G06T 19/006; G06F 3/012; G02B 27/0172; G02B 27/0093; G02B 27/0176; G02B 2027/014; G02B 2027/0154

(57) ABSTRACT

The present invention relates to an eyeglass lens comparison simulation system using virtual reality headset device including: a first user terminal configured to receive at least one parameter relating to virtual eyeglass lens images; a second user terminal configured to produce and output virtual vision control effect images according to the at least one parameter received from the first user terminal; and a virtual reality headset device configured to accommodate the second user terminal thereinto, wherein the virtual vision control effect images are produced by overlaying virtual user-customized eyeglass lens images produced according to the at least one parameter on any one of real environmental images and virtual environmental images.

### CROSS-REFERENCE TO RELATED APPLICATION

This patent document claims priority from, and the benefits of, Korean Patent Application No. 10-2015-0116072, filed on Aug. 18, 2015, the entirety of which is hereby incorporated by reference.

### TECHNICAL FIELD

This patent document relates to vision correction techniques, devices and systems.

### BACKGROUND

Various conventional techniques of providing an eyeglass lens to a wearer include obtaining wearer's vision-related information such as degrees of vision, astigmatism, or distance between two eyes and manufacturing an appropriate eyeglass lens using a prefabricated eyeglass lens based on the vision-related information. Even though the prescription information on the wearer's vision is recognized, by the way, the process for making the eyeglass lenses optimized to the individual person can be substantially complicated, and usually requires careful fabrication so that the fabricated lenses precisely meet the individual's vision needs per the doctor's prescription.

### SUMMARY

This patent document relates to a vision correction technology by producing vision corrected images using a virtual reality headset without wearing vision correction lenses, including an eyeglass lens comparison simulation system using virtual reality headset and method thereof. Some implementations of the disclosed technology relate to an eyeglass lens comparison simulation system using virtual reality headset and method thereof that provides an optimal customized vision correction product for a user through virtual experiences with a variety of vision correction products.

Various implementations of the disclosed technology provide an eyeglass lens comparison simulation system using virtual reality headset and method thereof that provides an optimal customized vision correction product for a user through virtual experiences with a variety of vision correction products and allows the user to experience the effects of wearing a variety of vision correction products.

In one aspect, there is provided an eyeglass lens comparison simulation system using virtual reality headset including: a first user terminal configured to receive at least one parameter that relates to one or more virtual eyeglass lens images; and a second user terminal configured to receive the at least one parameter from the first user terminal and produce virtual user-customized eyeglass lens images and virtual vision control effect images based on the at least one parameter received from the first user terminal, the virtual vision control effect images obtained by overlaying the virtual user-customized eyeglass lens images on real environmental images or virtual environmental images.

In some implementations, the at least one parameter includes at least one of lens power, lens color, lens type, lens size, outdoor setting, indoor setting, time setting, weather setting, or whether to select augmented reality selection.

In some implementations, the second user terminal includes: a motion sensor configured to sense the motion of the second user terminal and outputting the sensed signal; and a controller configured to change and output the virtual vision control effect images in response to the sensed signal received from the motion sensor, and the motion sensor includes at least any one of an accelerometer sensor, a gyroscope sensor, a compass sensor, a motion recognition sensor, a gravity sensor, a terrestrial magnetism sensor, a displacement sensor, a mercury switch, a ball switch, a spring switch, a tilt switch, or a step counter switch.

In some implementations, the second user terminal outputs the virtual vision control effect images corresponding to user's both eyes.

In some implementations, the virtual reality headset device includes: a body unit detachably connected to the second user terminal; a first lens and a second lens disposed inside the body unit, the first lens and the second lens corresponding to both eyes of the user, respectively; and PD (Pupillary Distance) adjusting units for adjusting at least one of the positions of the first lens or the second lens in accordance with the pupillary distance of the user.

In some implementations, the virtual reality headset device further includes VCD (Vertex Cornea Distance) adjusting units for adjusting a distance between the corneal vertex of the user and the back surface optical center of at least one of the first lens or the second lens.

In some implementations, the virtual reality headset device further includes a contact portion unit having a shape corresponding to a portion around the user's eyes, and the contact portion unit has at least one area including an elastic member.

In some implementations, the virtual reality headset device further includes a holder unit for mounting the second user terminal thereon, the holder unit having a shape adjustable according to the shape of the second user terminal.

In some implementations, the virtual reality headset device further includes a cover unit disposed on at least one area of the body unit to accommodate the second user terminal, the cover unit being hinge-coupled to the body unit to open and close the body unit.

In some implementations, the body unit further includes a partition unit disposed at the interior of the body unit to separate the first lens and the second lens from each other.

In another aspect, an eyeglass lens comparison simulation method using virtual reality headset is provided. The method includes: receiving at least one parameter for virtual eyeglass lens images from a first user terminal; producing virtual user-customized eyeglass lens images according to the received at least one parameter; producing virtual vision control effect images by overlaying the virtual user-customized eyeglass lens images on any one of real environmental images or virtual environmental images; and outputting the virtual vision control effect images.

In some implementations, the eyeglass lens comparison simulation method further includes: sensing a motion of the second user terminal and outputting the sensed signal; and changing and outputting the virtual vision control effect images in response to the sensed signal.

In some implementations, the real environmental images are the images photographed by a camera unit of the second user terminal.

In some implementations, wherein the producing virtual vision control effect images further comprises: if the at least one parameter received from the first user terminal includes an anti-fog setting, adjusting at least one of a degree of fog or a speed at which fog disappears according to a lens type included in the at least one parameter.

In some implementations, wherein anti-fog setting is included in the at least one parameter when sound produced from the user is within a first frequency range.

In some implementations, if the at least one parameter received from the first user terminal includes anti-dust setting, the producing of the virtual user-customized eyeglass lens images is performed while dust is attached.

In some implementations, the eyeglass lens comparison simulation method further comprises, after the producing virtual vision control effect images removing the dust attached to the lenses in response to a dust removal attempt command received from the first user terminal.

In some implementations, the eyeglass lens comparison simulation method further comprises repeating the removing of the dust based on a lens type included in the at least one parameter.

In some implementations, the dust removal attempt command is included in the at least one parameter when the sound produced from the user is within a second frequency range.

In some implementations, wherein the producing virtual vision control effect images further comprises: if at least one parameter received from the first user terminal includes an anti-fatigue setting, adding a virtual display screen according to the position of a virtual screen object recognized through a camera unit of the second user terminal.

### BRIEF DESCRIPTION OF THE DRAWINGS

FIG. 1 is a perspective view showing an exemplary eyeglass lens comparison simulation system using a virtual reality headset.

FIG. 2 is a front view showing a first user terminal and a second user terminal of an exemplary eyeglass lens comparison simulation system.

FIG. 3a is a top perspective view of a virtual reality headset of an exemplary eyeglass lens comparison simulation system.

FIG. 3b is a rear view of a virtual reality headset of an exemplary eyeglass lens comparison simulation system.

FIG. 3c is a bottom perspective view of a virtual reality headset of an exemplary eyeglass lens comparison simulation system.

FIG. 4 is a flowchart showing an exemplary eyeglass lens comparison simulation method using a virtual reality headset.

FIG. 5 is a flowchart showing another eyeglass lens comparison simulation method using a virtual reality headset.

FIGS. 6a to 6c are photographs showing a first example in use of an eyeglass lens comparison simulation system.

FIGS. 7a to 7c are photographs showing a second example in use of an eyeglass lens comparison simulation system.

FIGS. 8a to 8d are photographs showing a third example in use of an eyeglass lens comparison simulation system.

FIGS. 9a to 9d are photographs showing a fourth example in use of an eyeglass lens comparison simulation system.

FIGS. 10a to 10d are photographs showing a fifth example in use of an eyeglass lens comparison simulation system.

FIGS. 11a to 11d are photographs showing a sixth example in use of an eyeglass lens comparison simulation system.

FIGS. 12a to 12e are photographs showing a seventh example in use of an eyeglass lens comparison simulation system.

FIG. 13 is a photograph showing an eighth example in use of an eyeglass lens comparison simulation system.

FIGS. 14a to 14h are photographs showing a ninth example in use of an eyeglass lens comparison simulation system.

### DETAILED DESCRIPTION

The disclosed vision correction technology by producing vision corrected images using a virtual reality headset can assist individuals with certain vision impairments or defects without requiring such individuals to wear appropriately prescribed and actually fabricated vision correction lenses.

For example, even if the information on the wearer's vision is recognized by a medical specialist, people have different habits in seeing and also have their favorite lens sizes and shapes. Accordingly, appropriate eyeglass lenses for the wearer should be selected through separate lots of measurement equipment. In this case, if the eyeglass lenses are not appropriate for him or her after being selected, they should be discarded, and new appropriate eyeglass lenses should be made again. Particularly, the above-mentioned problems become serious in the process of making functional lenses having complicated structures, such as progressive addition lenses, myopia control lenses, eye fatigue reduction lenses, photochromic lenses, polarized lenses, and so on. The disclosed vision correction technology can produce vision corrected images using a virtual reality headset to mitigate the need for appropriately prescribed and actually fabricated vision correction lenses and to provide a better vision.

Hereinafter, various implementations of and examples of certain features of an eyeglass lens comparison simulation system using virtual reality headset and method thereof are described with reference to the attached drawings. While the disclosed technology is illustrated and described in the disclosed embodiments and examples, many different configurations, forms, and characteristics can be implemented based on what is described and illustrated. Those skilled in the art will envision many other possible variations within the scope of the disclosed technology. In the description, similar reference numerals in the drawings have the same or similar functions as each other or to each other, and the thicknesses of the lines or the sizes of the components shown in the drawing may be magnified for the clarity and convenience of the description.

The term ‘coupled’ or ‘connected’, as used herein, is defined as being connected with or connected to, although not necessarily directly, and not necessarily mechanically. To the contrary, the term ‘directly coupled’ or ‘directly connected’, as used herein, is defined as connected without having any component disposed therebetween. Further, the term ‘including’ and/or ‘having’, as used herein are intended to refer to the above features, numbers, steps, operations, elements, parts or combinations, and it is to be understood that the terms are not intended to preclude the presence of one or more features, numbers, steps, operations, elements, parts or combinations and added possibilities.

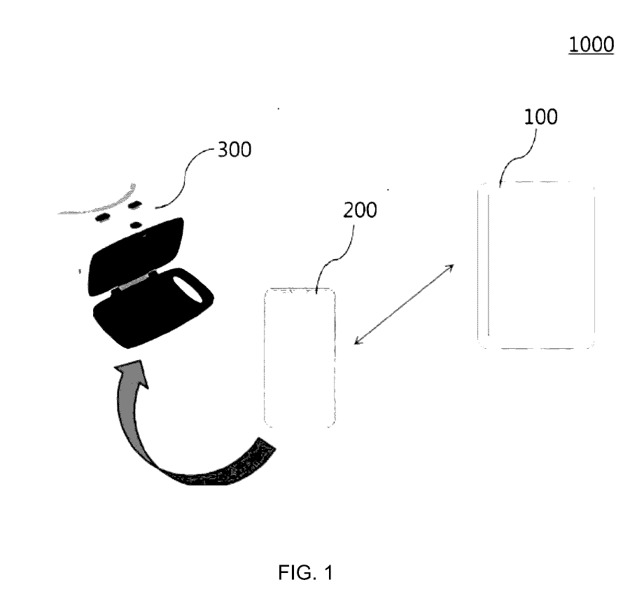

FIG. 1 is a perspective view showing an exemplary eyeglass lens comparison simulation system using a virtual reality headset.

As shown in FIG. 1, an eyeglass lens comparison simulation system according to one implementation of the disclosed technology includes a first user terminal 100, a second user terminal 200 and a virtual reality headset 300.

First, the first user terminal 100 receives at least one parameter for virtual eyeglass lens images from a user. In this case, the at least one parameter includes at least one of lens power, lens color, lens type, lens size, outdoor setting, indoor setting, time setting, weather setting, and augmented reality selection or non-selection. The first user terminal 100 transmits the at least one parameter received from the user to the second user terminal 200 through wired or wireless communication, and the second user terminal 200 produces virtual vision control effect images according to the at least one parameter received from the first user terminal 100. The first user terminal 100 as shown in FIG. 1 may be implemented by a variety of terminals capable of performing data communications via wired links or wireless links, such as user computer, smartphone, tablet PC, and others. Accordingly, the first user terminal 100 may be implemented in a particular configuration based on the needs of a particular application setting or conditions and may be changed when the disclosed technology is used in different applications that may have different particular requirements. Those variations for the first user terminal 100 are within the known range to the person having ordinary skill in the art.

The second user terminal 200 produces and outputs the virtual vision control effect images according to the at least one parameter received from the first user terminal 100. In this case, the virtual vision control effect images mean the images on the virtual environment or object seen when a vision correction product is worn on the user. First, virtual user-customized eyeglass lens images are produced according to the at least one parameter received from the first user terminal 100, and the produced virtual customized eyeglass lens images are then overlaid on any one of real environmental images and virtual environmental images, thus producing the virtual vision control effect images. The second user terminal 200 as shown in FIG. 1 includes a portable terminal like a smartphone. However, the second user terminal 200 may include a variety of terminals capable of performing data communications via wired links or wireless links, and accordingly, the second user terminal 200 may be implemented in a particular configuration based on the needs of a particular application setting or conditions and may be changed when the disclosed technology is used in different applications that may have different particular requirements. Those variations for the second user terminal 200 are within the known range to the person having ordinary skill in the art.

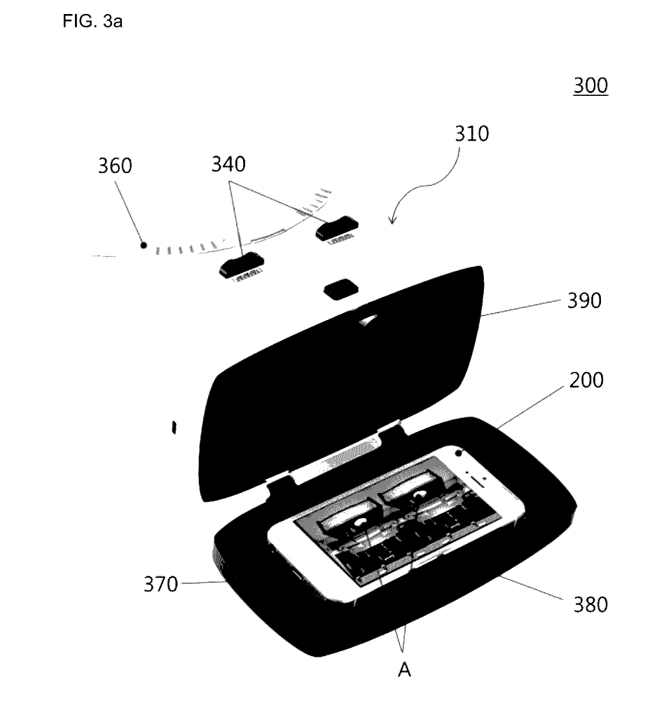

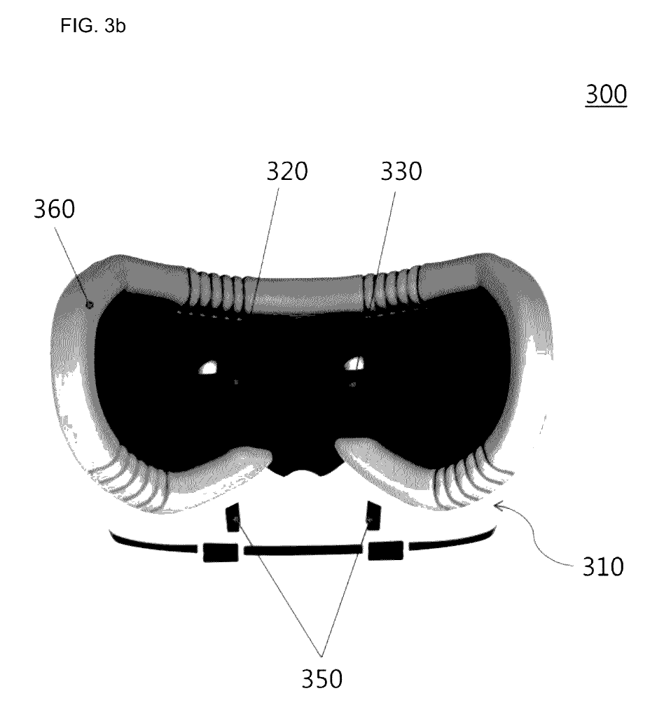

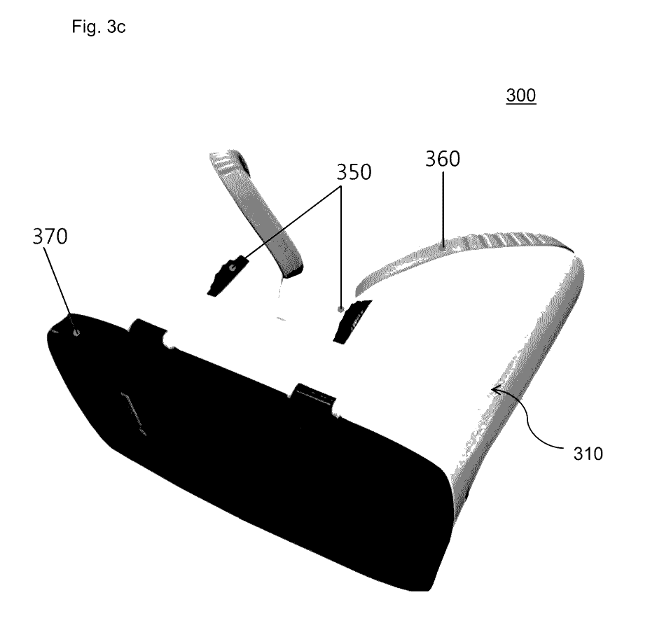

The virtual reality headset 300 is provided to co-operate with, or accommodate, the second user terminal 200. In some implementations, the virtual reality headset 300 may perform certain operations or provide certain functions by using hardware components in the second user terminal 200 or in junction with the second user terminal 200. For example, the virtual reality headset 300 may not have any additional display unit therein, but is coupled with the second user terminal 200 to utilize the display unit built in the second user terminal 200 for displaying information in connection with operations or functions of the virtual reality headset 300. For another example, the virtual reality headset 300 may use the virtual vision control effect images stored and produced by the second user terminal 200. For yet another example, the virtual reality headset 300 may be designed to allow the virtual vision control effect images outputted from the second user terminal 200 to be seen similar to the real environment through a motion sensor and a camera unit of the second user terminal 200. Accordingly, in those implementations, certain advantages or benefits can be achieved from the virtual reality headset 300 that is configured to use or share certain features or/and information in the second user terminal 200. For example, the disclosed technology may be used to mitigate the problems of some conventional vision correction products to be purchased by the user if selected eyeglass lenses are not appropriate for individual users (e.g., due to imprecision in manufacturing of the lenses) and would require such inappropriate lenses to be discarded. A configuration of the virtual reality headset 300 will be in detail explained later with reference to FIGS. 3a to 3c.

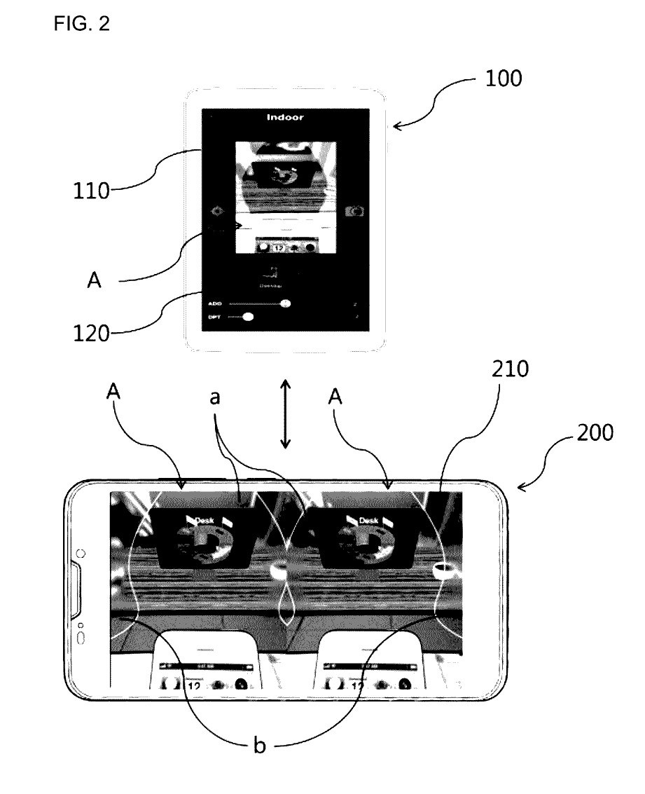

FIG. 2 is a front view showing the first user terminal and the second user terminal of the eyeglass lens comparison simulation system according to one implementation of the disclosed technology, wherein virtual vision control effect images are displayed through their respective display units.

As shown in FIG. 2, first, the first user terminal 100 includes a first display unit 110 and a first communication unit (not shown).

The first display unit 110 displays an interface screen 120 for receiving at least one parameter and provides the interface screen 120 for the user. Further, the first display unit 110 displays virtual vision control effect images A that are the same as the virtual vision control effect images A outputted from the second user terminal 200. The first display unit 110 is formed on the external surface of the first user terminal 100, connected to an external device, or has a form of a touch screen. The first display unit 110 may include a variety of display devices applicable to the first user terminal 100, such as CRT monitors, LCDs, LEDs, OLEDs, and the like, which are known to the person having ordinary skill in the art.

The interface screen 120 receives at least one parameter from the user. The at least one parameter includes at least one of lens power, lens color, lens type, lens size, outdoor setting, indoor setting, time setting, weather setting, and augmented reality selection or non-selection. In this context, the lens power means the parameters for quantifying the degrees of the user's myopia, astigmatism, hyperopia, and presbyopia, and the lens color means the parameters for indicating the colors of the lens. The lens type means the parameters for indicating the lens types selected according to the user's vision, such as progressive addition lens, spherical lens, aspheric lens, double sided aspheric lens, myopia control lens, eye fatigue reduction lens, functional coating lens like anti-fog coating lens, anti-dust coating lens, anti-scratch coating lens, anti-reflection coating lens, anti-smudge coating lens, hydrophobic coating lens, and blue light cut-off coating lens, polarized lens, soft lens, and hard lens. Further, the lens size means the parameters for indicating the horizontal and vertical lengths of the lens, and outdoor setting and indoor setting mean the parameters for determining whether the virtual vision control effect images A outputted from the first display unit 110 are outdoor images or indoor images. The weather setting means the parameters for determining various weather environments like a clear day, a cloudy day, and a rainy day, and so on in the virtual vision control effect images A. The augmented reality selection or non-selection means the parameters for determining that the virtual vision control effect images are produced on the basis of the actual or real environment images inputted through the camera unit of the second user terminal 200 if the augmented reality is selected and the virtual vision control effect images are produced on the basis of the virtual environment images previously made if the augmented reality is not selected. As shown in FIG. 2, the interface screen 120 is displayed on the first display unit 110 being in the form of the touch screen, but it is just exemplary. The first user terminal 100 may include a variety of input devices for receiving interface signals from the user, such as keyboards, mouse, and the like, which can be implemented in any one of suitable implementations within the known range to the person having ordinary skill in the art.

The first communication unit within the first user terminal 100 transmits the at least one parameter received in the first user terminal 100 to the second user terminal 200. The first communication unit can include a communication module supporting at least one of a variety of wired and wireless communication methods, such as internet communication using TCP/IP, WiFi (Wireless Fidelity), Bluetooth, and so on, and accordingly, the first communication unit may be implemented in any one of the suitable implementations within the known range to the person having ordinary skill in the art.

In implementations, the second user terminal 200 includes a second display unit 210, a second communication unit (not shown), and a controller (not shown).

The second display unit 210 displays the virtual vision control effect images A produced by the second user terminal 200 and provides them for the user. In one particular example, as shown in FIG. 2, the second display unit 210 produces two virtual vision control effect images A corresponding to both eyes of the user. For example, the second display unit 210 displays the two virtual vision control effect images A in consideration of and correcting the undesired effects of the binocular parallax (the difference between the angles of left and right eyes when an object is seen) and provides an artificial three-dimensional image without having the undesired effects of the binocular parallax for the user, thus making him or her feel like he or she actually wears a vision correction product without having to actually wear a vision correction product.

In operation, the second communication unit within the second user terminal 200 receives the at least one parameter from the first user terminal 100 and transmits the received parameter to the controller. Further, the second communication unit transmits the information on the virtual vision control effect images A produced by the controller of the second user terminal 200 to the first user terminal 100. The second communication unit includes a communication module supporting at least one of a variety of wire and wireless communication methods, such as internet communication using TCP/IP, WiFi (Wireless Fidelity), Bluetooth, and so on, and accordingly, the first communication unit may be implemented in any one of the suitable implementations within the known range to the person having ordinary skill in the art.

The controller produces the virtual vision control effect images A according to the at least one parameter received from the first user terminal 100 and outputs the produced virtual vision control effect images A to the second display unit 210. More specifically, the controller produces the virtual user-customized eyeglass lens images a according to the at least one parameter received from the first user terminal 100. As such, the virtual user-customized eyeglass lens images a indicate the images that are the same as in the vision corrected state formed on the eyeglass lenses when the user wears a vision correction product manufactured on the basis of his or her vision, for example, when he or she wears eyeglasses to which the at least one parameter is applied. Next, the controller overlays real environmental images b or virtual environmental images (not shown) on the virtual user-customized eyeglass lens images a, thus producing the virtual vision control effect images A. Accordingly, the second user terminal 200 makes the same situation as when the vision correction product is really worn on the user, thus allowing the user to have virtual experiences. In this case, the real environmental images b indicate the images on the actual or real environment at which the user is located, and so as to photograph the real environmental images b of the user, the second user terminal 200 further includes a camera unit (not shown). Further, the virtual environmental images indicate processed environmental images previously stored in the second user terminal 200 or transmitted from an external device.

In this example, the controller processes the images stored in the second user terminal 200, the images photographed by the camera unit of the second user terminal 200, or the images received from other devices through local/wide area communication network. Accordingly, the controller processes various kinds of images received from the second user terminal 200 and provides the virtual vision control effect images A that make the same situation as when the vision correction product is worn on the user.

In the example as shown in FIG. 2, the controller outputs the two virtual vision control effect images A corresponding to both eyes of the user to the second display unit 210. Accordingly, the controller processes the virtual vision control effect images A seen by his or her left and right eyes in consideration of his or her binocular parallax and provides them correspondingly to his or her left and right eyes.

In implementing the disclosed technology, the second user terminal 200 can include, in some implementations, a motion sensor (not shown). The motion sensor senses the motion of the second user terminal 200 and outputs the sensed signal. The controller changes and outputs the virtual vision control effect images A in response to the sensed signal received from the motion sensor. The motion sensor includes at least any one of an accelerometer sensor, a gyroscope sensor, a compass sensor, a motion recognition sensor, a gravity sensor, a terrestrial magnetism sensor, a displacement sensor, a mercury switch, a ball switch, a spring switch, a tilt switch, and a step counter switch. The sensed signal produced by the motion sensor is the signal indicating the motion of the second user terminal 200 and includes the information on acceleration, direction and motion time of the second user terminal 200. The controller processes and corrects the virtual vision control effect images A according to the sensed signal received from the motion sensor. For example, if the user turns his or her head, the controller corrects the virtual environmental images in accordance with his or her motion to provide the virtual vision control effect images A. Further, if the user turn his or her head, the controller collects the real environmental images seen by him or her through the camera unit of the second user terminal 200, processes the collected images, and outputs the changed virtual vision control effect images A. As the user turns his or her head, accordingly, various environments or objects seen when the vision correction product is worn on him or her can be virtually experienced.

Moreover, the second user terminal 200 transmits the virtual vision control effect images A changed by the sensed signal produced by the motion sensor to the first user terminal 100. Accordingly, the first user terminal 100 displays the same images as the virtual vision control effect images A displayed by the second user terminal 200 through the first display unit 110. As a result, the user of the first user terminal 100 is provided with the virtual vision control effect images A that are the same as the user of the second user terminal 200.

FIG. 3a is a top perspective view showing the virtual reality headset of the eyeglass lens comparison simulation system according to an implementation of the disclosed technology, FIG. 3b is a rear view showing the virtual reality headset of the eyeglass lens comparison simulation system in this implementation of the disclosed technology, and FIG. 3c is a bottom perspective view showing the virtual reality headset of the eyeglass lens comparison simulation system in this implementation of the disclosed technology.

As shown in FIGS. 3a to 3c, the virtual reality headset 300 of the eyeglass lens comparison simulation system includes a body unit 310, a first lens 320 and a second lens 330. In this implementation, the virtual reality headset 300 further includes PD (Pupillary Distance) adjusting units 340, VCD (Vertex Cornea Distance) adjusting units 350, a contact portion unit 360, a cover unit 370, a holder unit 380, and a partition unit 390.

The body unit 310 is worn on at least a portion of the user's face in such a manner as to be detachable from the second user terminal 200. The body unit 310 has a shape having a structure in which the virtual reality headset 300 is easily worn on the user's face, and for example, the body unit 310 has a curved surface and a groove capable of covering the user's eye and nose regions. Particularly, as shown in FIGS. 3a to 3c, the contact portion unit 360 is formed on the rear surface of the body unit 310 in such a manner as to have a shape corresponding to a portion around the user's eyes. The contact portion unit 360 has at least one area made of an elastic member like silicone, and since the contact portion unit 360 comes into contact with the user's eye region, accordingly, it may be exchanged with new one whenever the user is changed to other users, thus improving the sanitary state of the virtual reality headset 300. The contact portion unit 360 may be made of various materials capable of protecting the user's face and providing elastic restoring force, such as rubber, sponge, and so on.

Moreover, the body unit 310 accommodates the second user terminal 200 thereinto. As the second user terminal 200 is mounted on the body unit 310, the virtual reality headset 300 makes use of the second display unit 210 and the motion sensor of the second user terminal 200 and the information stored in the second user terminal 200. Accordingly, the virtual reality headset 300 does not need any cables for the connection of other devices, and further, it is simplified in configuration.

As shown in FIGS. 3a and 3c, the virtual reality headset 300 further includes a cover unit 370 disposed on at least one area of the body unit 310 to accommodate the second user terminal 200 thereinto, and the cover unit 370 is hinge-coupled to the body unit 310 to open and close the at least one area of the body unit 310 in which the second user terminal 200 is accommodated.

Further, as shown in FIG. 3a, the virtual reality headset 300 further includes a holder unit 380 formed on at least one area of the cover unit 370 to mount the second user terminal 200 thereon. The holder unit 380 serves to prevent the second user terminal 200 from being changed in position due to external shocks or the user's motion and is adjustable in shape to mount the second user terminal 200 having a variety of shapes thereon. For example, the holder unit 380 makes use of an elastic material, and otherwise, it is structurally varied in size, thus stably mounting the second user terminal 200 thereon, irrespective of the size of the second user terminal 200. Further, as shown in FIG. 3a, the body unit 310 further includes a partition unit 390 disposed at the interior thereof to separate the first lens 320 and the second lens 330 from each other. The partition unit 390 serves to prevent the user's both eyes from hindering the two virtual vision control effect images A outputted from the second user terminal 200 and further allows the virtual reality headset 300 to provide a three-dimensional image having more sense of reality for the user.

The first lens 320 and the second lens 330 are located inside the body unit 310 in such a manner as to correspond to the user's both eyes. The first lens 320 and the second lens 330 serve to transmit the two virtual vision control effect images A outputted from the second user terminal 200 to the user's left and right eyes. If the virtual reality headset 300 is worn on the user, accordingly, the two virtual vision control effect images A can be seen with the sense of reality. Further, the first lens 320 and the second lens 330 are adjustable in position and angle through the user's manipulation.

The PD adjusting units 340 adjust at least one of the positions of the first lens 320 and the second lens 330 in accordance with the pupillary distance of the user. As shown in FIG. 3a, the PD adjusting units 340 are formed on at least one area of the external surface of the body unit 310. The distance between the first lens 320 and the second lens 330 is adjusted through the user's manipulation of the PD adjusting units 340. For example, if the pupillary distance of the user is short, the distance between the first lens 320 and the second lens 330 becomes reduced through the user's manipulation of the PD adjusting units 340. Contrarily, if the pupillary distance of the user is far, the distance between the first lens 320 and the second lens 330 becomes increased through the user's manipulation of the PD adjusting units 340. According to this particular implementation of the disclosed technology, the PD adjusting units 340 move the first lens 320 and the second lens 330 in every direction.

Further, as shown in FIG. 3a, the PD adjusting units 340 are formed in the shape of wheels, but they are just exemplary. Accordingly, the PD adjusting units 340 may have a variety of shapes such as dials, touch pads, slide buttons, and so on. Furthermore, the two PD adjusting units 340 individually adjust the first lens 320 and the second lens 330. As the positions of the first lens 320 and the second lens 330 are adjusted through the user's manipulation of the PD adjusting units 340, the images are adjusted and provided according to the user's physical characteristics and vision. In this particular implementation of the disclosed technology, the moving distances of the first lens 320 and the second lens 330 by means of the PD adjusting units 340 are measured and utilized in manufacturing the vision correction product.

The VCD adjusting units 350 adjust a distance (Vertex Cornea Distance) between the corneal vertex of the user and the back surface optical center of at least one of the first lens 320 and the second lens 330. As shown in FIG. 3c, the VCD adjusting units 350 are formed on at least one area of the external surface of the body unit 310. The front and rear positions of the first lens 320 and the second lens 330 are adjusted through the user's manipulation of the VCD adjusting units, so that the distance between the corneal vertex of the user and the back surface optical center of at least one of the first lens 320 and the second lens 330 can be adjusted.

As shown in FIG. 3c, the VCD adjusting units 350 are formed in the shape of wheels, but they are just exemplary. Accordingly, the VCD adjusting units 350 may have a variety of shapes such as dials, touch pads, slide buttons, and so on. Furthermore, the two VCD adjusting units 350 individually adjust the first lens 320 and the second lens 330. As the front and rear positions of the first lens 320 and the second lens 330 are adjusted through the user's manipulation of the VCD adjusting units 350, the images are adjusted and provided according to the user's physical characteristics and vision. In certain implementations of the disclosed technology, the front and rear positions of the first lens 320 and the second lens 330 by means of the VCD adjusting units 350 are measured and utilized in manufacturing the vision correction product.

In implementing the disclosed technology, the body unit 310 can further include terminal position adjusters (not shown) for adjusting the position of the second user terminal 200. Accordingly, the second user terminal 200 is moved near to and far from the first lens 320 and the second lens 330 through the user's manipulation of the terminal position adjusters. Further, the terminal position adjusters adjust the second user terminal 200 in every direction.

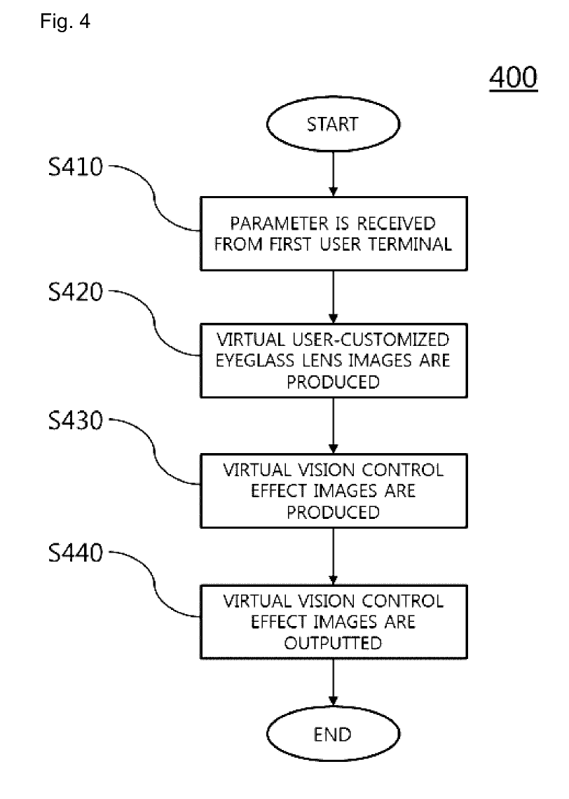

FIG. 4 is a flowchart showing an eyeglass lens comparison simulation method using a virtual reality headset according to one implementation of the disclosed technology.

As shown in FIG. 4, an eyeglass lens comparison simulation method using a virtual reality headset according to one implementation of the disclosed technology includes the step of transmitting at least one parameter for the virtual eyeglass lens images from the first user terminal 100 to the second user terminal 200 (at step S410). In this case, the at least one parameter includes at least one of lens power, lens color, lens type, lens size, outdoor setting, indoor setting, time setting, weather setting, and augmented reality selection or non-selection.

Next, the method includes the step of producing the virtual user-customized eyeglass lens images a according to the at least one parameter from the second user terminal 200 (at step S420). In this case, the virtual user-customized eyeglass lens images a indicate the images that are the same as in the vision corrected state formed on the vision correction product manufactured on the basis of the vision of the user.

After that, the method includes the step of overlaying the virtual user-customized eyeglass lens images a on any one of the real environmental images b or the virtual environmental images to produce the virtual vision control effect images A through the second user terminal 200 (at step S430). The controller of the second user terminal 200 overlays the virtual user-customized eyeglass lens images a on any one of the real environmental images b or the virtual environmental images to produce the virtual vision control effect images A.

According to the illustrated implementation of the disclosed technology in FIG. 4, at least one of the steps S420 and S430, the real environmental images b indicate the images photographed by the camera unit of the second user terminal 200. That is, the real environment at which the user is located is in real time photographed by the camera unit of the second user terminal 200, and the photographed images are processed by the controller to produce the real environmental images b.

Finally, the method in FIG. 4 includes the step of outputting the virtual vision control effect images A through the second display unit 210 of the second user terminal 200 (at step S440). At this time, the controller of the second user terminal 200 outputs the two virtual vision control effect images A corresponding to both eyes of the user to the second display unit 210.

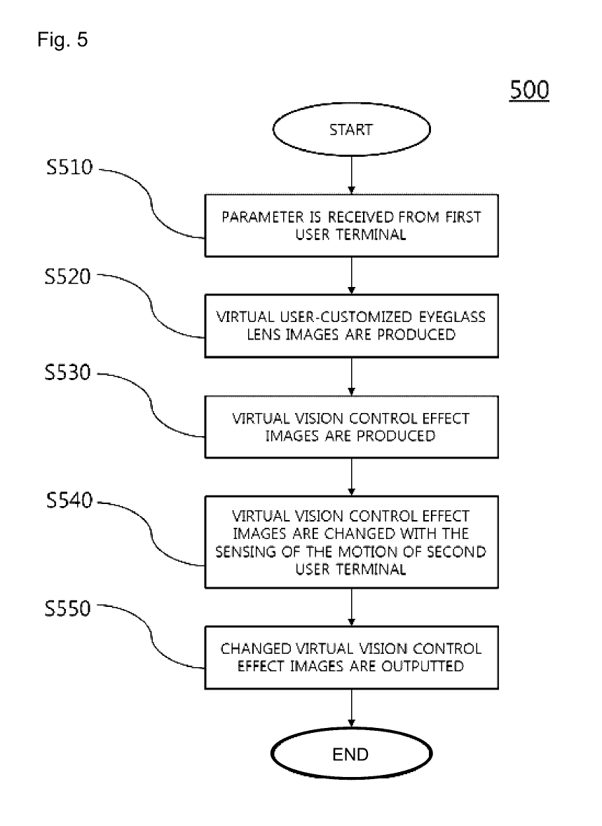

FIG. 5 is a flowchart showing another eyeglass lens comparison simulation method using a virtual reality headset according to an implementation of the disclosed technology.

Steps 510 to S530 are the same as the steps S410 to S430 of FIG. 4, and therefore, an explanation on them will be avoided for the brevity of the description.

As shown in FIG. 5, the eyeglass lens comparison simulation method using a virtual reality headset according to this particular implementation of the disclosed technology includes the step of, if the motion sensor of the second user terminal 200 senses the motion of the second user terminal 200 and outputs the sensed signal therefrom, changing the virtual vision control effect images A in response to the sensed signal received from the motion sensor of the second user terminal 200 (at step S540). In more detail, the sensed signal produced by the motion sensor is the signal indicating the motion of the second user terminal 200 and includes the information on acceleration, direction and motion time of the second user terminal 200. The controller processes and corrects the virtual vision control effect images A according to the sensed signal received from the motion sensor. For example, if the user turns his or her head, the controller corrects the virtual environmental images in accordance with his or her motion to provide the virtual vision control effect images A. Further, if the user turn his or her head, the controller collects the real environmental images seen by him or her through the camera unit of the second user terminal 200, processes the collected images, and outputs the changed virtual vision control effect images A. As the user turns his or her head, accordingly, various environments or objects seen when the vision correction product is worn on him or her can be virtually experienced.

Next, the eyeglass lens comparison simulation method includes the step of outputting the changed virtual vision control effect images A through the second display unit 210 (at step S550). Accordingly, the virtual vision control effect images A moving together with the user's motion are supplied from the second user terminal 200 to him or her.

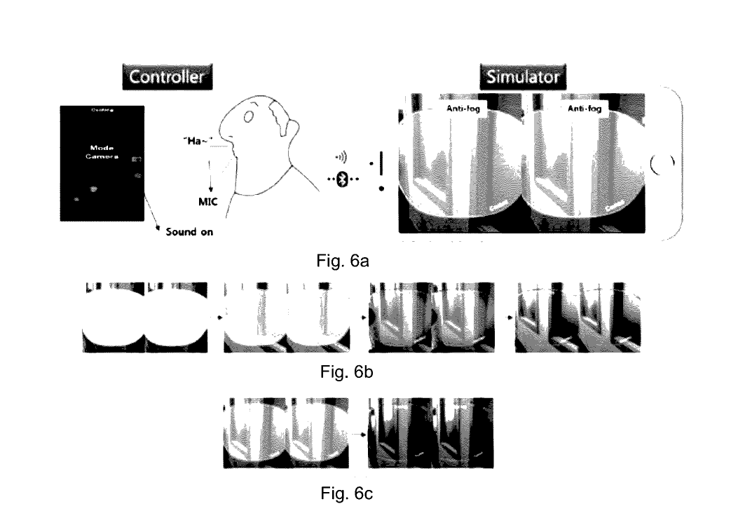

FIGS. 6a to 6c are photographs showing a first example in use of the eyeglass lens comparison simulation system according to an implementation of the disclosed technology, wherein the virtual vision control effect images A to which anti-fog coating lenses are applied are illustrated.

As shown in FIG. 6a, the sound produced from the user is analyzed by the first user terminal (controller), and if it is determined that the sound is within the range of a first frequency, the first user terminal transmits anti-fog setting to the second user terminal (simulator). That is, if the user breathes on a mike of the first user terminal, the first user terminal analyzes the frequency of the sound (for example, “Ha”) produced by the steam of breath of the user, and thus, if it is determined that the sound is within the range of the first frequency previously set, the first user terminal recognizes that the user breathes on the mike thereof. Accordingly, the anti-fog setting is transmitted to the second user terminal.

If the anti-fog setting is contained in the at least one parameter received from the first user terminal, the second user terminal adjusts at least one of a degree of fog and a speed at which fog disappears according to the lens type contained in the at least one parameter and produces the virtual user-customized eyeglass lens images.

As shown in FIG. 6b, if the lens type contained in the at least one parameter received from the first user terminal is an uncoated lens, the virtual vision control effect images are densely fogged up at an initial step, and further, a speed at which the fog disappears becomes slow, so that the fog on the lenses disappears after a long time.

Contrarily, as shown in FIG. 6c, if the lens type contained in the at least one parameter received from the first user terminal is an anti-fog coating lens, the virtual vision control effect images are slightly fogged up at an initial step, and further, a speed at which the fog disappears becomes fast, so that the fog on the lenses disappears even after a short time. Accordingly, the user who wears the virtual reality headset on which the second user terminal is mounted can feel the effects of the anti-fog coating lenses instinctively.

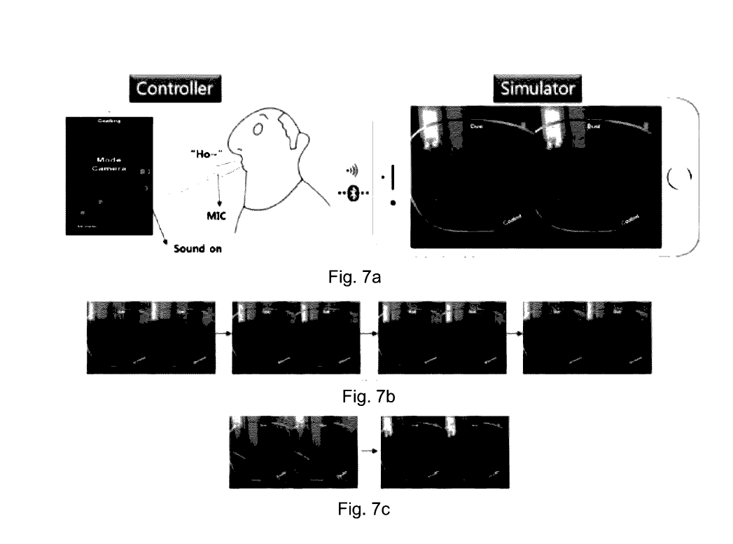

FIGS. 7a to 7c are photographs showing a second example in use of the eyeglass lens comparison simulation system according to an implementation of the disclosed technology, wherein the virtual vision control effect images A to which anti-dust coating lenses are applied are illustrated.

As shown in FIG. 7a, if anti-dust setting is contained in the at least one parameter received from the first user terminal (controller), the second user terminal (simulator) produces and displays the virtual user-customized eyeglass lens images to which dust is attached. Further, the second user terminal additionally displays the real environmental images or the virtual environmental images covered with dust.

Next, the sound produced from the user is analyzed by the first user terminal, and if it is determined that the sound is within the range of a second frequency, the first user terminal transmits a dust removal attempt command to the second user terminal. That is, if the user blows on the mike of the first user terminal, the first user terminal analyzes the frequency of the sound (for example, “Ho” or “Hoo”) produced by the blowing of the user, and thus, if it is determined that the sound is within the range of the second frequency previously set, the first user terminal recognizes that the user blows on the mike thereof. Accordingly, the dust removal attempt command is transmitted to the second user terminal.

The second user terminal removes a given amount of dust attached to the lenses in response to the dust removal attempt command received from the first user terminal and adjusts the number of dust removal attempt command times through which the dust on the lenses is completely removed according to the lens type contained in the at least one parameter received from the first user terminal.

As shown in FIG. 7b, if the lens type contained in the at least one parameter received from the first user terminal is an uncoated lens, the dust removal attempt command should be inputted several times (for example, 10 times or more) so as to completely remove the dust attached to the lenses on the virtual vision control effect images displayed on the second user terminal. That is, the user should blow on the mike of the first user terminal several times so as to completely remove the dust attached to the lenses.

Contrarily, as shown in FIG. 7c, if the lens type contained in the at least one parameter received from the first user terminal is an anti-dust coating lens, the dust attached to the lenses is completely removed through the input of the dust removal attempt command with the small number of times (for example, three times). That is, even if the user blows on the mike of the first user terminal with the small number of times, the dust attached to the lenses can be completely removed. Accordingly, the user who wears the virtual reality headset on which the second user terminal is mounted can feel the effects of the anti-dust coating lenses instinctively.

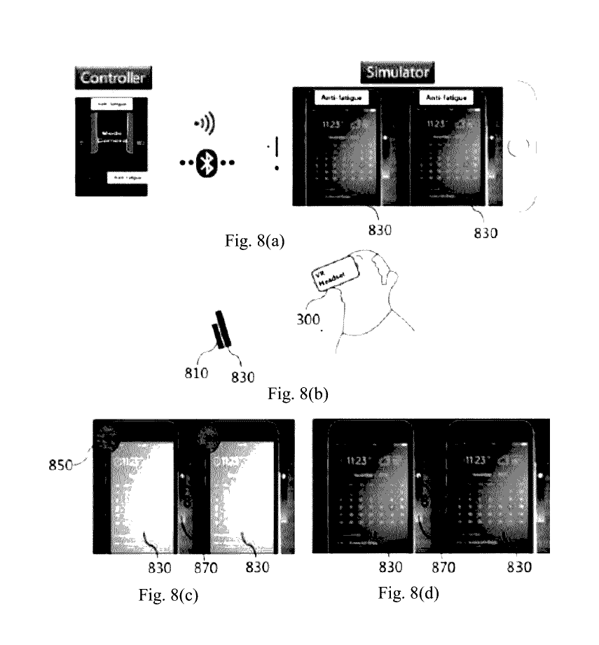

FIGS. 8a to 8d are photographs showing a third example in use of the eyeglass lens comparison simulation system according to an implementation of the disclosed technology.

As shown in FIG. 8a, if anti-fatigue setting is contained in the at least one parameter received from the first user terminal (controller), the second user terminal (simulator) produces the virtual vision control effect images to display the effects of the anti-fatigue lenses.

As shown in FIG. 8b, if the anti-fatigue setting is contained in the at least one parameter received from the first user terminal, the controller of the second user terminal adds a virtual display screen 830 according to the position of a virtual screen object 810 recognized through the camera unit of the second user terminal attached to the virtual reality headset 300 and produces the virtual user-customized eyeglass lens images. That is, the virtual display screen 830 as shown in FIG. 8a displayed on the screen of the second user terminal is the virtual screen (for example, smartphone screen) displayed on a position wherein the virtual screen object 810 is recognized.

For example, the virtual screen object 810 may be a card on which a given logo or code is printed, and if the logo or code is recognized as the virtual screen object 810 through the analysis of the second user terminal 300, the second user terminal 300 displays the virtual display screen 830 on the position of the virtual screen object 810.

Further, the virtual screen object 810 is taken by the user's hand and then moves up and down, thus allowing the distance between the camera unit of the second user terminal and the virtual screen object 810 to be appropriately adjusted. Accordingly, the size of the virtual display screen 830 displayed on the second user terminal is adjusted.

At this time, the time during which the virtual display screen 830 becomes unclear can be adjusted in accordance with the distance between the virtual screen object 810 and the camera unit and the lens type contained in the at least one parameter received from the first user terminal.

As shown in FIG. 8c, if the lens type contained in the at least one parameter received from the first user terminal is not an anti-fatigue lens, but a normal lens, the user's eyes feel tired in a short time to make the virtual display screen 830 unclear. So as to indicate the unclearness of the virtual display screen 830 due to the eye fatigue in such a short time, further, a time image 850 is displayed on the screen of the second user terminal. Furthermore, the distance between the camera unit of the second user terminal and the virtual screen object 810 is displayed through a circular icon 875 contained in a range window 870. If the distance between the camera unit of the second user terminal and the virtual screen object 810 becomes short, the circular icon 875 enters a red area on the top of the range window 870, so that the virtual display screen 830 becomes unclear to cause the user's eyes to feel easily tired.

Contrarily, as shown in FIG. 8d, if the lens type contained in the at least one parameter received from the first user terminal is an anti-fatigue lens, the user's eyes do not feel tired after a long time to make the virtual display screen 830 kept clear. The red area on the top of the range window 870 as shown in FIG. 8c is reduced in size to indicate that the distance in which the virtual display screen 830 can be clearly seen becomes increased. Accordingly, the user who wears the virtual reality headset on which the second user terminal is mounted can feel the effects of the anti-fatigue coating lenses instinctively.

On the other hand, the distance between the camera unit of the second user terminal and the virtual screen object 810, as shown in FIGS. 8c and 8d, is in the range of 25 to 30 cm.

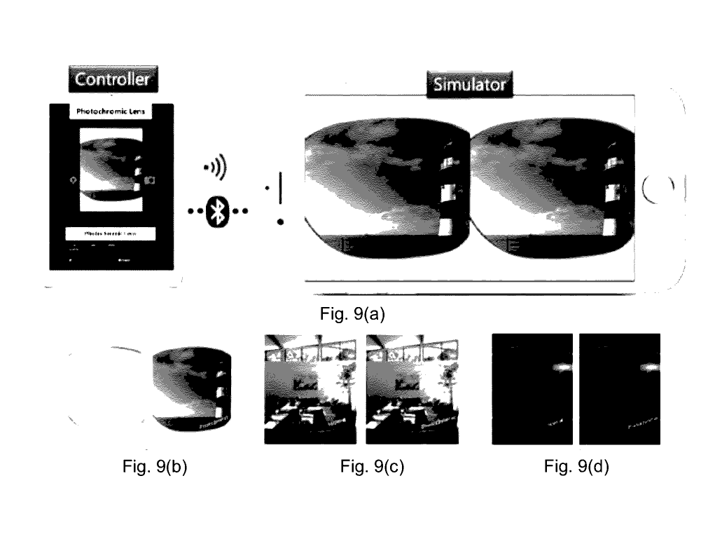

FIGS. 9a to 9d are photographs showing a fourth example in use of the eyeglass lens comparison simulation system according to an implementation of the disclosed technology, wherein the virtual vision control effect images A to which photochromic lenses are applied are illustrated.

As shown in FIG. 9a, if the lens type contained in the at least one parameter received from the first user terminal (controller) is a photochromic lens, the second user terminal (simulator) produces the virtual vision control effect images to display the effects of the photochromic lenses.

FIG. 9b shows daytime and outdoor images, FIG. 9c shows indoor images, and FIG. 9d shows nighttime images. As shown in FIGS. 9b to 9d, left images are images to which normal lenses are applied, and right images are images to which photochromic lenses are applied. Accordingly, the user who wears the virtual reality headset on which the second user terminal is mounted can feel the effects of the anti-fatigue coating lenses instinctively.

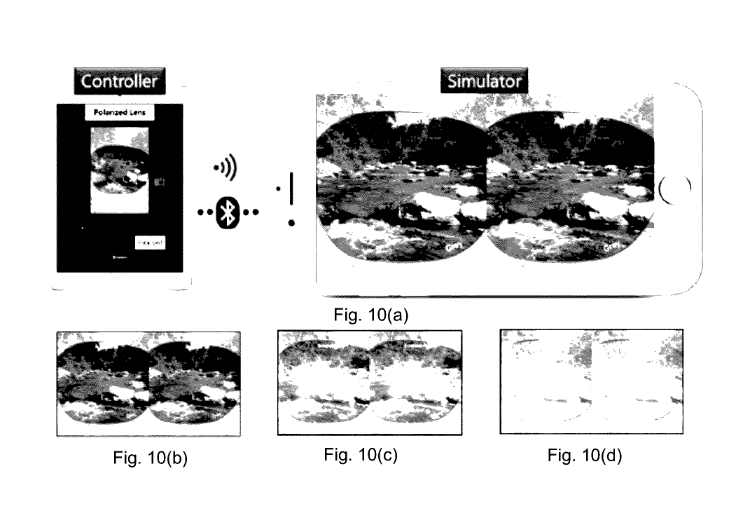

FIGS. 10a to 10d are photographs showing a fifth example in use of the eyeglass lens comparison simulation system according to an implementation of the disclosed technology, wherein the virtual vision control effect images A to which polarized lenses are applied are illustrated.

As shown in FIG. 10a, if the lens type contained in the at least one parameter received from the first user terminal (controller) is a polarized lens, the second user terminal (simulator) produces the virtual vision control effect images to display the effects of the polarized lenses.

FIG. 10b shows polarized sunglass images, FIG. 10c shows normal sunglass images, and FIG. 10d shows normal eyeglass images. Accordingly, the user who wears the virtual reality headset on which the second user terminal is mounted can feel the effects of the polarized lenses instinctively.

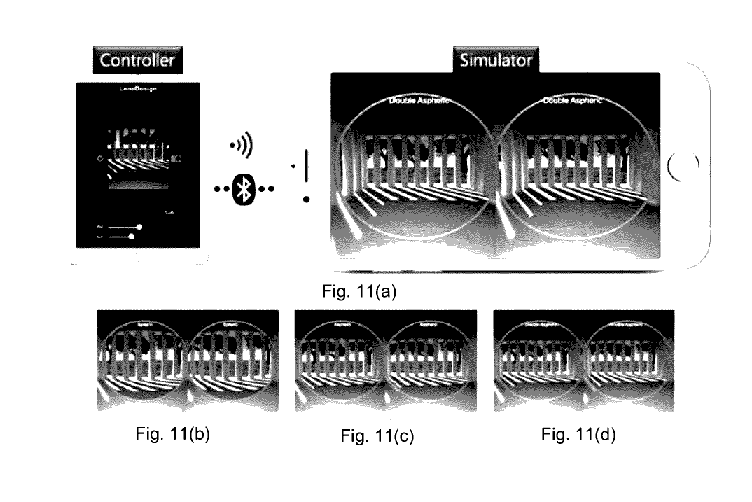

FIGS. 11a to 11d are photographs showing a sixth example in use of the eyeglass lens comparison simulation system according to an implementation of the disclosed technology, wherein the virtual vision control effect images A to which a variety of lens designs are applied are illustrated.

As shown in FIG. 11a, if the lens type contained in the at least one parameter received from the first user terminal (controller) is a spherical lens, aspheric lens, or double sided aspheric lens, the second user terminal (simulator) produces the virtual vision control effect images to display the effects of the various lenses.

FIG. 11b shows spherical lens images, FIG. 11c shows aspheric lens images, and FIG. 11d shows double sided aspheric lens images. Accordingly, the user who wears the virtual reality headset on which the second user terminal is mounted can feel the differences among the spherical lens, the aspheric lens and the double sided aspheric lens instinctively.

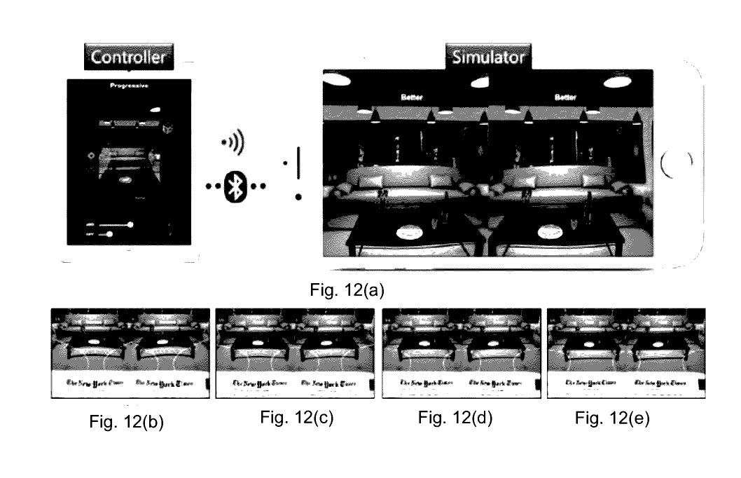

FIGS. 12a to 12e are photographs showing a seventh example in use of the eyeglass lens comparison simulation system according to an implementation of the disclosed technology, wherein the virtual vision control effect images A to which progressive addition lenses are applied are illustrated.

As shown in FIG. 12a, if the lens type contained in the at least one parameter received from the first user terminal (controller) is a progressive addition lens, the second user terminal (simulator) produces the virtual vision control effect images to display the effects of the progressive addition lenses.

FIG. 12b shows images to which progressive addition lenses set to “Standard” are applied, FIG. 12c shows images to which progressive addition lenses set to “Good” are applied, FIG. 12d shows images to which progressive addition lenses set to “Better” are applied, and FIG. 12e shows images to which progressive addition lenses set to “Best” are applied. Accordingly, the user who wears the virtual reality headset on which the second user terminal is mounted can feel the effects of various modifications of the progressive addition lenses instinctively.

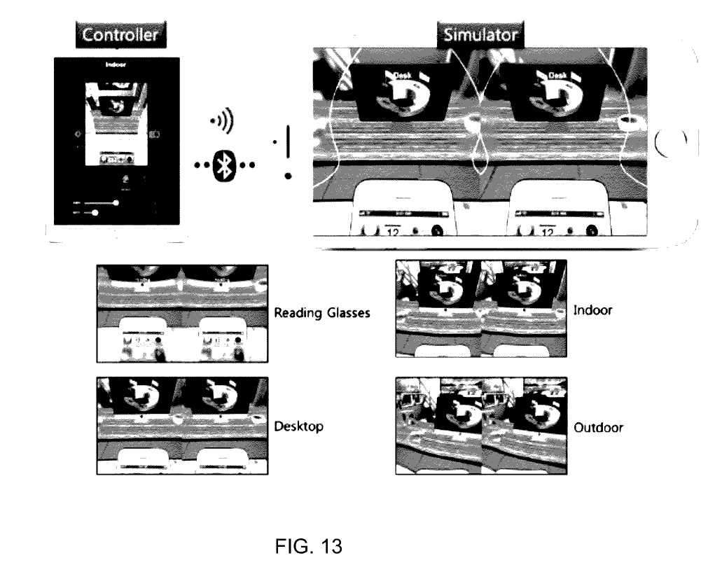

FIG. 13 is a photograph showing an eighth example in use of the eyeglass lens comparison simulation system according to an implementation of the disclosed technology, wherein the virtual vision control effect images A through which the effects of the lenses in various environments are compared with each other are illustrated.

As shown in FIG. 13, if outdoor and indoor setting is contained in the at least one parameter received from the first user terminal (controller), the second user terminal (simulator) displays the virtual vision control effect images A through which the effects of the lenses in various environments (for example, “Reading glasses”, “Indoor”, “Desktop”, and “Outdoor”) are compared with each other. Accordingly, the user who wears the virtual reality headset on which the second user terminal is mounted can feel the effects of the lenses in various environments instinctively.

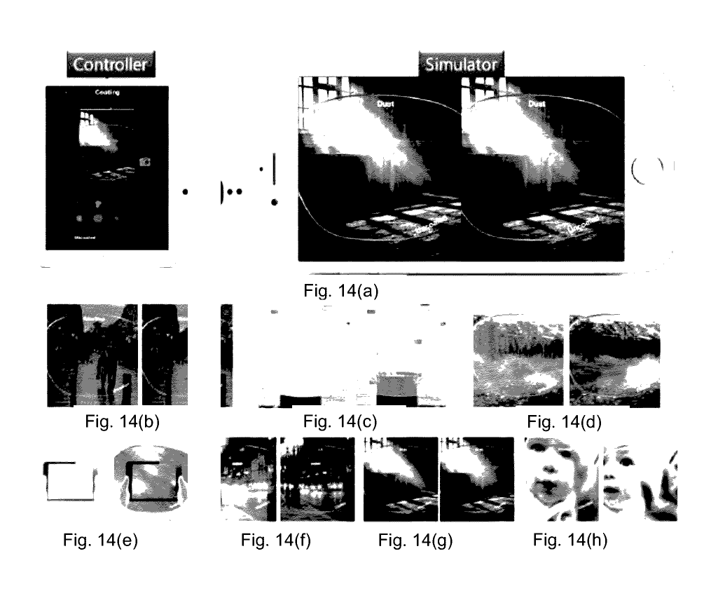

FIGS. 14a to 14h are photographs showing a ninth example in use of the eyeglass lens comparison simulation system according to an implementation of the disclosed technology, wherein the virtual vision control effect images A through which the effects of various functional coating lenses are compared with each other are illustrated.

As shown in FIG. 14a, if the lens type contained in the at least one parameter received from the first user terminal (controller) is a functional coating lens, the second user terminal (simulator) produces the virtual vision control effect images to display the effects of the functional coating lenses.

FIG. 14b shows images to which hydrophobic coating lenses are applied, FIG. 14c shows images to which an anti-fog coating lens is applied, and FIG. 14d shows images to which an anti-scratch coating lens is applied. Further, FIG. 14e shows images to which a blue light cut-off coating lens is applied, FIG. 14f shows images to which an anti-reflection coating lens is applied, FIG. 14g shows images to which an anti-dust coating lens is applied, and FIG. 14h shows images to which an anti-smudge coating lens is applied.

As shown in FIGS. 14b to 14h, the left images are images to which normal lenses are applied, and the right images are images to which functional coating lenses are applied. Accordingly, the user who wears the virtual reality headset on which the second user terminal is mounted can feel the effects of the functional coating lenses instinctively.

On the other hand, the virtual vision control effect images as shown in FIG. 6a to 14h are processed and produced by the controller of the second user terminal 200 and displayed on the second display unit 210 of the second user terminal 200.

As described above, the eyeglass lens comparison simulation system using virtual reality headset and method thereof based on the disclosed technology provides an optimal customized vision correction product for the user through virtual experiences with a variety of vision correction products and allows the user to experience the effects of wearing a variety of vision correction products.

Further, the eyeglass lens comparison simulation system using virtual reality headset and method thereof based on the disclosed technology makes functional eyeglass lenses requiring complicated manufacturing steps and precious checking in a more precise manner.

Additionally, the eyeglass lens comparison simulation system using virtual reality headset and method thereof based on the disclosed technology connects a portable terminal like a smartphone to the virtual reality headset in a convenient manner, thus allowing the virtual vision control effect images to be three-dimensionally provided for the user.

While the disclosed technology has been described with reference to the particular illustrative embodiments, other implementations are also possible. It is to be appreciated that those skilled in the art can change or modify the embodiments without departing from the scope and spirit of the disclosed technology.

What is claimed is:

1. An eyeglass lens comparison simulation system using a virtual reality headset comprising:
a first user terminal configured to receive at least one parameter that relates to one or more virtual eyeglass lens images; and
a second user terminal configured to receive the at least one parameter from the first user terminal and produce virtual user-customized eyeglass lens images and virtual vision control effect images based on the at least one parameter received from the first user terminal, the virtual vision control effect images obtained by overlaying the virtual user-customized eyeglass lens images on real environmental images or virtual environmental images.

2. The eyeglass lens comparison simulation system using virtual reality headset according to claim 1,
wherein the at least one parameter comprises at least one of lens power, lens color, lens type, lens size, outdoor setting, indoor setting, time setting, weather setting, or whether to select augmented reality.

3. The eyeglass lens comparison simulation system using virtual reality headset according to claim 1,
wherein the second user terminal comprises:
a motion sensor configured to sense the motion of the second user terminal and outputting the sensed signal; and
a controller configured to change and output the virtual vision control effect images in response to the sensed signal received from the motion sensor,
and the motion sensor comprises at least any one of an accelerometer sensor, a gyroscope sensor, a compass sensor, a motion recognition sensor, a gravity sensor, a terrestrial magnetism sensor, a displacement sensor, a mercury switch, a ball switch, a spring switch, a tilt switch, or a step counter switch.

4. The eyeglass lens comparison simulation system using virtual reality headset according to claim 1,
wherein the second user terminal outputs the virtual vision control effect images corresponding to user's both eyes.

5. The eyeglass lens comparison simulation system using virtual reality headset according to claim 1,
wherein the virtual reality headset comprises:
a body unit detachably connected to the second user terminal;
a first lens and a second lens disposed inside the body unit, the first lens and the second lens corresponding to both eyes of the user, respectively; and
PD (Pupillary Distance) adjusting units for adjusting at least one of the positions of the first lens or the second lens in accordance with the pupillary distance of the user.

6. The eyeglass lens comparison simulation system using virtual reality headset according to claim 5,
wherein the virtual reality headset device further comprises VCD (Vertex Cornea Distance) adjusting units for adjusting a distance between the corneal vertex of the user and the back surface optical center of at least one of the first lens or the second lens.

7. The eyeglass lens comparison simulation system using virtual reality headset according to claim 5,
wherein the virtual reality headset device further comprises a contact portion unit having a shape corresponding to a portion around the user's eyes, and the contact portion unit has at least one area including an elastic member.

8. The eyeglass lens comparison simulation system using virtual reality headset according to claim 5,
wherein the virtual reality headset device further comprises a holder unit for mounting the second user terminal thereon, the holder unit having a shape adjustable according to the shape of the second user terminal.

9. The eyeglass lens comparison simulation system using virtual reality headset according to claim 5, wherein the virtual reality headset device further comprises a cover unit disposed on at least one area of the body unit to accommodate the second user terminal, the cover unit being hinge-coupled to the body unit to open and close the body unit.

10. The eyeglass lens comparison simulation system using virtual reality headset according to claim 5,
wherein the body unit further comprises a partition unit disposed at the interior of the body unit to separate the first lens and the second lens from each other.

11. An eyeglass lens comparison simulation method using virtual reality headset comprising the steps of:
receiving at least one parameter for virtual eyeglass lens images from a first user terminal
producing virtual user-customized eyeglass lens images according to the received at least one parameter;
producing virtual vision control effect images by overlaying the virtual user-customized eyeglass lens images on any one of real environmental images or virtual environmental images; and
outputting the virtual vision control effect images.

12. The eyeglass lens comparison simulation method using virtual reality headset according to claim 11, further comprising the steps of:
sensing a motion of the second user terminal and outputting the sensed signal; and
changing and outputting the virtual vision control effect images in response to the sensed signal.

13. The eyeglass lens comparison simulation method using virtual reality headset according to claim 11, wherein the real environmental images are the images photographed by a camera unit of the second user terminal.

14. The eyeglass lens comparison simulation method using virtual reality headset according to claim 11, wherein the producing virtual vision control effect images further comprises:
if the at least one parameter received from the first user terminal includes an anti-fog setting, adjusting at least one of a degree of fog or a speed at which fog disappears according to a lens type included in the at least one parameter.

15. The eyeglass lens comparison simulation method using virtual reality headset according to claim 14,
wherein anti-fog setting is included in the at least one parameter when sound produced from the user is within a first frequency range.

16. The eyeglass lens comparison simulation method using virtual reality headset according to claim 11,
wherein if the at least one parameter received from the first user terminal includes anti-dust setting, the producing of the virtual user-customized eyeglass lens images is performed while dust is attached.

17. The eyeglass lens comparison simulation method using virtual reality headset according to claim 16, further comprising, after the producing virtual vision control effect images, removing the dust attached to the lenses in response to a dust removal attempt command received from the first user terminal.

18. The eyeglass lens comparison simulation method using virtual reality headset according to claim 16, further comprising repeating the removing of the dust based on a lens type included in the at least one parameter.

19. The eyeglass lens comparison simulation method using virtual reality headset according to claim 16,
wherein the dust removal attempt command is included in the at least one parameter when sound produced from the user is within a second frequency range.

20. The eyeglass lens comparison simulation method using virtual reality headset according to claim 11, wherein the producing virtual vision control effect images further comprises:
if at least one parameter received from the first user terminal includes an anti-fatigue setting, adding a virtual display screen according to the position of a virtual screen object recognized through a camera unit of the second user terminal.
